(19) United States
(12) Patent Application Publication
(10) Pub. No.: US 2023/0300034 A1
(43) Pub. Date: Sep. 21, 2023

(54) AI-POWERED ALGORITHM TO FILL GAPS IN SIGNAL STRENGTH MAPS

(71) Applicant: Telefonaktiebolaget LM Ericsson (publ), Stockholm (SE)

(72) Inventors: Jose Maria RUIZ AVILES, MÁLAGA (ES); Paulo Antonio MOREIRA MIJARES, MÁLAGA (ES); Juan RAMIRO MORENO, MÁLAGA (ES); Adriano MENDO MATEO, MÁLAGA (ES); Jose OUTES CARNERO, TORREMOLINOS (ES); Yak NG MOLINA, MÁLAGA (ES)

(21) Appl. No.: 18/022,239

(22) PCT Filed: Feb. 9, 2021
(86) PCT No.: PCT/EP2021/053047

§ 371 Date: Feb. 20, 2023

(30) Foreign Application Priority Data
Aug. 28, 2020 (EP) 20382767.0

(51) Int. Cl. H04L 41/16; H04W 16/22

(52) U.S. Cl. CPC H04L 41/16; H04W 16/22

(57) ABSTRACT

Methods and devices for signal strength prediction. In one aspect, a machine learning model is trained using physical cell information and geographic information to derive features corresponding to a region of a cell with a known signal strength value. The machine learning model can be used to predict signal strength values for other regions of the cell.

### TECHNICAL FIELD

Disclosed are embodiments related to methods and apparatuses for managing a wireless communication network. Some aspects relate to training machine learning models and the use of such models for signal strength prediction.

### BACKGROUND

Prediction of signal strength has been widely studied by the mobile communications industry. The understanding of radio propagation and its characteristics in different environments (e.g. dense urban, urban, and suburban environments) has become important for a number of activities, such as identifying locations for new sites, estimation of coverage areas, and parameter optimization. Propagation models can be used to predict signal strength for a given environment. One such model is provided by 3GPP TR 38.901, “Study on Channel Model for Frequencies from 0.5 to 100 GHz” (2016), which evaluates the performance of physical layer techniques using the channel model across frequency bands. Some models may use ray tracing techniques, local calibration of classical models, and map or satellite images of a particular area.

However, there remains a need for improved signal strength prediction techniques.

### SUMMARY

According to embodiments, methods and apparatuses use a machine learning algorithm that makes use of physical cell information, the signal strength measurements of the cell, elevation information, and/or the type of terrain in the cell to predict the signal strength in areas without signal strength measurements. Inputs are used to train models at the cell level using information of regions where the signal strength is known, and then these models are used to predict the signal strength in other regions in the cell where the signal strength is not known.

According to embodiments, a method of generating a machine learning model is provided. The method may comprise, for instance: inputting physical cell information corresponding to a first plurality of regions in a first cell of a wireless communication network; inputting geographic information corresponding to the first plurality of regions; deriving one o [symbol] more features for each of the first plurality of regions based on the cell information and the geographic information; obtaining a set of labels indicating signal strength values correspondi [symbol] to each of the first plurality of regions; and generating a trained machine learning model for th [symbol] first cell based on the derived features and the obtained set of labels. In certain aspects, the trained model can be applied to predict signal strength values corresponding to other, different regions in the cell.

According to embodiments, a method of managing a wireless communication network is provided. The method may comprise, for instance: obtaining one or more features [symbol] at least one region of a cell in the wireless communication network, wherein the one or more features are based at least in part on physical cell properties and geographic properties of the a [symbol] least one region; and predicting a signal strength value for the at least one region by applying t [symbol] one or more features to a machine learning model corresponding to the cell. In certain aspects obtaining the features may comprise inputting physical cell information corresponding to the a least one region; inputting geographic information corresponding to the at least one region; an [symbol] deriving the one or more features from the input physical cell and geographic information. A report with the predicted signal strength values can then be transmitted, for example, to an operator.

According to embodiments, a method of training a machine learning model is provided. The method may comprise, for instance: providing a machine learning model for predicting signal strength values in a cell of a wireless communication network; and training t [symbol] model based on features of a plurality of regions in the cell and known signal strength values o [symbol] the plurality of regions. In certain aspects, the features are based on physical cell information and geographic information for the plurality of regions.

According to embodiments, an apparatus is provided that is configured to perfo [symbol] one or more of the disclosed methods.

According to embodiments, an apparatus is provided comprising a memory and processor, wherein the processor is configured to perform one or more of the disclosed method

According to embodiments, a computer program is provided. In certain aspects the computer program comprises instructions that, when executed by processing circuitry of ar [symbol] apparatus, cause the apparatus to perform one or more of the disclosed methods. A carrier ma [symbol] contain the computer program, such as an electronic signal, an optical signal, a radio signal, or computer readable storage medium.

### BRIEF DESCRIPTION OF THE DRAWINGS

The accompanying drawings, which are incorporated herein and form part of th [symbol] specification, illustrate various embodiments.

FIG. 1 illustrates a wireless communication network according to embodiments

FIG. 2 illustrates a wireless communication network according to embodiments

FIG. 3 is a flow chart illustrating processes according to embodiments.

FIG. 4 is a flow chart illustrating processes according to embodiments.

FIG. 5 is a flow chart illustrating machine learning model training and signal strength prediction processes according to embodiments.

FIGS. 6A and 6B are flow charts illustrating processes according to embodimen

[symbol]

FIGS. 7A and 7B are flow charts illustrating processes according to embodimen

[symbol]

FIG. 8 is a schematic block diagram of a device according to embodiments.

FIG. 9 is a schematic block diagram of a device according to embodiments.

FIG. 10 is a schematic block diagram of a device according to embodiments.

FIGS. 11A and 11B illustrate prediction results.

### DETAILED DESCRIPTION

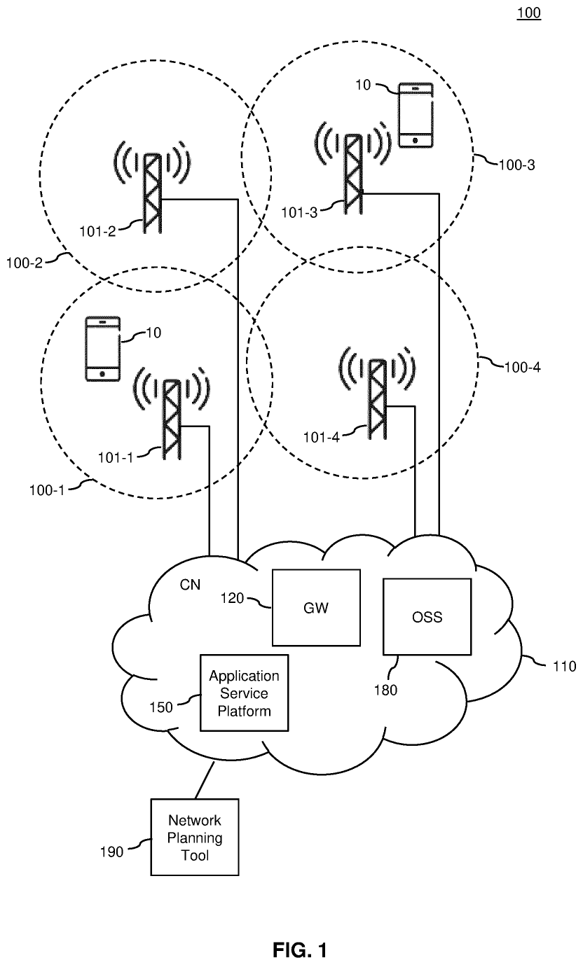

Referring now to FIG. 1, a wireless communication network 100 is illustrated according to embodiments. In this example, the wireless communication network 100 covers multiple cells 100-1, 100-2, 100-3, 100-4, with each cell being served by a corresponding acce [symbol] node 101-1, 101-2, 101-3, 101-4. The access nodes 101-1, 101-2, 101-3, 101-4 may for exam [symbol] correspond to eNBs of the LTE technology or to gNBs of the NR technology. Additionally, o [symbol] or more User Equipment (UEs) 10 may be connected to the wireless communication network 100. The UEs 10 may correspond to various kinds of wireless devices, including user terminal mobile or stationary computing devices like smartphones, laptop computers, desktop compute [symbol] tablet computers, gaming devices, or the like. Further, the UEs 10 s may correspond to other kinds of equipment, such smart home devices, printers, multimedia devices, data storage devic [symbol] or the like.

As illustrated in FIG. 1, each of the UEs 10 may connect through a radio link to one or more of the access nodes 101-1, 101-2, 101-3, 101-4. For example, depending on location or channel conditions experienced by a UE 10, an appropriate cell 100-1, 100-2, 100- [symbol] 100-4 and access node 101-1, 101-2, 101-3, 101-4 may be selected for establishing the radio link. In certain embodiments, the radio link may be based on one or more OFDM (orthogonal frequency multiplexing) carriers in a frequency band supported by the wireless communicatio [symbol] network 100. However, depending on the utilized radio technology, other modulation techniq [symbol] or wireless connections may be used as well.

According to embodiments, each access node 101-1, 101-2, 101-3, 101-4 may provide data connectivity for the UEs 10 connected to it. Additionally, the access nodes 101- [symbol] 101-2, 101-3, 101-4 may be further connected to a core network (CN) 110 of the wireless communication network 100. The CN 110 may ensure data connectivity among different UEs 10 connected to the wireless communication network, as well as data connectivity of the UEs to other entities, e.g., to one or more servers, service providers, data sources, data links, user terminals, or the like. As such, the CN 110 may include one or more gateways 120, such as an SGW (Serving Gateway) and/or PGW (Packet Data Network) of the LTE technology or a UP [symbol] (User Plane Function) of the NR technology. Additionally, embodiments may be used with legacy services, including GSM and Wideband Code Division Multiplexing Access (WCMDA The radio link established between a UE 10 and the wireless communication network may be used for providing various kinds of services to the UE 10, e.g., a voice service, a multimedia service, or other data service. Such services may be based on applications that are executed or the UE 10 and/or on a device linked to the UE 10. By way of example, FIG. 1 illustrates an application service platform 150 provided in the CN 110. The application(s) executed on the [symbol] 10 and/or on one or more other devices linked to the UE 10 may use the radio link for data communication with one or more other UEs 10 and/or the application service platform 150, thereby enabling utilization of the corresponding service(s) at the UE 10.

With further reference to FIG. 1, and in some embodiments, the CN 110 may al [symbol] include an operational support system (OSS) 180. The OSS 180 may be responsible for configuring parameters relevant for operation of the wireless communication network, such as RF (radio frequency) parameters applied by the access nodes 101-1, 101-2, 101-3, 101-4 and/ [symbol] for collecting various data during operation of the wireless communication network. Such collected data may also include coverage data based on measurements performed by the acces [symbol] nodes 101-1, 101-2, 101-3, 101-4 and/or by the UEs 10. As further illustrated, a network planning tool 190 may also be provided. The network planning tool 190 may be used for planning modification and/or expansion of the wireless communication network 100, as well a configuration of one or more devices of the network (e.g., an access node or UE). For these purposes, the network planning tool 190 may utilize data provided by the OSS 180, as well as machine learning models and predicted values according to embodiments.

According to embodiments, methods and devices can predict signal strength in given region or “pixel” of a network. Where an area (e.g., cell) is divided into small squares ( [symbol] other shapes), and each pixel can represent one of these regions. Signal strength can be predic [symbol] based on signal strength measurements in the same cell, or similar cells in the same (or in a similar) network.

For example, for one or more cells in a network, signal strength can be predicte [symbol] for all the pixels in its area of influence, making use of a subset of pixels in that area and/or pixels served/influenced by similar cells in the same network. In other words, for an incomple [symbol] propagation map, embodiments can be used to fill the map by predicting the signal strength in the pixels where it is unknown. In certain aspects, machine learning can be used to carry out these predictions. According to embodiments, to predict the signal strength, a set of features i [symbol] calculated for each pixel in the area of interest. These features, together with the signal strengl values of pixels with available measurements/estimations, are used to train a machine learning model, which is then used to predict the signal strength in pixels where the signal strength is unknown. Examples of features for each pixel can include: (a) cell parameters and antenna transmit power; (b) terrain information for the pixel and the path between the pixel and the antenna (e.g. elevation and type of terrain); and (c) geometric information (e.g. logarithm of th [symbol] distance, vertical and horizontal angles between the sample and the antenna, etc.). These features may be calculated based on information that is provided by the operator, which may have an updated antenna database, as well as clutter type and elevation maps of its networks. Further, signal strength measurements for each pixel can be collected from different sources, including: (a) crowdsourced data measurement datasets (e.g., data provided by third parties an [symbol] directly collected from applications installed on the UEs 10); (b) measurements reported by U [symbol] 10 in measurement messages if they are (or can be) geo-located (e.g. Minimization of Drive T [symbol] (MDT) or Cell Traffic Recording (CTR) traces in 4G); and (c) walk and drive tests. These measurements can be used as labels for the machine learning model during a training phase. Examples of signal strength values include Reference Signal Received Power (RSRP), Synchronization Signal RSRP (SS-RSRP), Channel State Information RSRP (CSI-RSRP), a New Radio Received Signal Strength Indicator (NR-RSSI), CSI-RSSI, and combinations of these (or other values), such as Reference Signal Received Quality (RSSQ) values. According embodiments, other power measurements or related values/indicators may also be used. For instance, power measurements of legacy technologies may be used, such as Receive Level (RxLev) of GSM and Receive Signal Code Power (RSCP) of WCDMA.

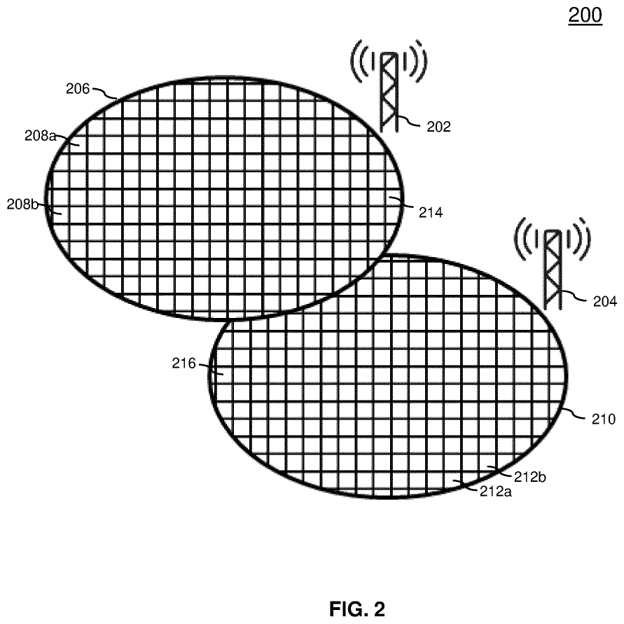

Referring now to FIG. 2, aspects of a wireless communication network 200 are illustrated according to embodiments. In this example, a first access node 202 covers a first ce [symbol] 206, and a second access node 204 covers a second cell 210. According to embodiments, acce [symbol] nodes 202 and 204 may correspond to one or more of access nodes 101-1, 101-2, 101-3, 101-4 shown in FIG. 1. Similarly, cells 206 and 210 may correspond to one or more of cells 100-1, 100-2, 100-3, 100-4 shown in FIG. 1. According to embodiments, each of the cells 206, 210 may comprise one or more regions. For instance, signal strength values may be known for a fi [symbol] group of regions, such as regions 208a, 208b in cell 206 and regions 212a, 212b in cell 210, bu [symbol] not known for other regions, such as region 214 in cell 206 and region 216 in cell 210. The known information for regions 208a, 208b can be used to predict information for region 214. Similarly, information for regions 212a, 212b can be used to predict information for region 21 [symbol] In particular, and according to embodiments, features regarding 208a, 208b can be used to trail machine learning model, for instance, a model for cell 206. Similarly, features regarding 212a 212b can be used to train a machine learning model for cell 210. According to embodiments, [symbol] known signal strength values for regions 208a, 208b, 212a, and/or 212b may be labels for the machine learning model training. Additionally, physical cell information and geographic information for these regions can be used to derive the set of features that are used for model training.

Once a model is trained, it can be used to predict signal strength values. For instance, the model for cell 206 can be used to predict a signal strength value in region 214 usi [symbol] the physical cell and geographic information of region 214. Similarly, the model for cell 210 [symbol] be used to predict a signal strength value in region 216 using the physical cell and geographic information of region 216.

In some embodiments, a machine learning model for a first cell (e.g., cell 206) can be trained, at least in part, using information from a second cell (e.g., information regardin [symbol] 212a, 212b in cell 210). For instance, if a region of a first cell (e.g., 206) has similar features (e.g., physical cell and/or geographic properties) as a region of a second cell (e.g., 210), the signal strength label for the region of the second cell may be used for the region of the first cel [symbol] Alternatively, the features and labels of regions in the second cell may be used directly when training a model for the first cell. That is, both the derived features and labels for one or more regions of a second cell can be input to the model training process for a first cell, for example, where the cells are sufficiently similar (e.g., meet a similarity threshold).

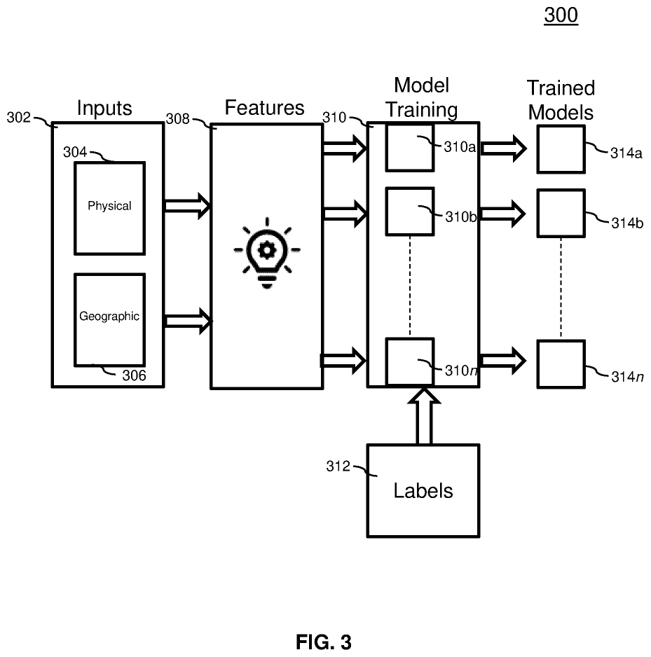

Referring now to FIG. 3, a process 300 is provided according to some embodiments. The process 300 can be used as a machine learning model training process. Process 300 may be applied, for instance, with respect to networks 100 and 200, including to generate models for cells 206 and 210.

As shown in FIG. 3, one or more inputs 302 can be used to generate features 30 These features are then be used in conjunction with labels 312 to train 310 one or more model [symbol] 314. According to embodiments, each model 314a-314n corresponds to a different coverage area, such as a cell of a wireless communications network. The models can be trained individually, or collectively (310a-310n) using a common set of derived features. In the exam [symbol] of FIG. 3, the inputs 302 include both physical inputs 304 relating to the cell (e.g., an access node of the cell, including one or more of its antennas) and geographic inputs 306 (e.g., clutter type and elevation data). Labels 312 are input to the model training. In this example, the labe [symbol] 312 indicate signal strength values (e.g., geo-located signal strength measurements) for variou [symbol] regions within an area corresponding to the model(s). For instance, each of the labels may be [symbol] a particular region of a cell, and include the signal strength relating to a particular access node. In this respect, the labels 312 may be considered antenna-power “pairs” in some embodiments. A region may have available signal measurements corresponding to different nodes and/or antennas.

According to embodiments, physical inputs 304 comprise information relating [symbol] a particular cell, such as cell 206 or 210, at a given location (e.g., region). Examples of inputs 304 can include one or more of a cell identifier, the latitude of an access node antenna, the longitude of the antenna, the azimuth of the antenna, the antenna tilt (e.g., the mechanical and/electrical tilt), and the antenna altitude over ground level. Additional physical inputs may be used, including other information regarding the cell, its nodes, and the antennas used by the nodes. According to embodiments, the geographic inputs 306 may comprise one or more of clutter type information and elevation information. The clutter type information may include, example, the type of terrain, discretized into a finite set of categories in each location with a certain spatial resolution. The elevation information may include, for example, the elevation o [symbol] the terrain over the sea level in each location with a certain spatial resolution. According to embodiments, one or more of the clutter type and elevation information may be derived from a map. In certain aspects, the inputs 306 may be one or more of a clutter type map and an elevation map.

As shown in FIG. 3, a set of labels 312 are used. According to embodiments, these labels are geo-located signal strength measurements. Such measurements can be collect [symbol] from different sources, and can include indoor and/or outdoor measurements. For examples, known signal strengths may be measured by UEs 10 and sent to the network (e.g., network 10 [symbol] in messages. These messages and measurements may be available in call traces files, and can geo-located with a number of techniques, including triangulation. Moreover, functionalities lil [symbol] MDT can allow for geo-lactation of each measurement. As another example, walk and drive tests may be used to obtain labels 312. These measurements are typically highly accurate in terms of geo-location, and can be designed in advance to maximize reliability. As another example, crowdsourced data can be used. For instance, geo-located signal strength measurements can be obtained from applications installed in the UEs 10. If available, this dat [symbol] source is easily accessible, allowing the collection of data over large and diverse areas, in a fas [symbol] and efficient way. In certain aspects, access to this data source can be carried out without operator collaboration, which may provide a benefit from the operator's point of view. Furthermore, the nature of the end-to-end process makes the methodology independent from t [symbol] network infrastructure vendor. According to embodiments, each of the signal strength measurements (from one or more of the sources) is associated to a particular cell, and it belon [symbol] to a particular region or pixel. Thus, in the same pixel, there could be several measurements from the same or different cells. In some embodiments, these measurements are aggregated at pixel-cell level and, in order to increase the reliability of the input, if the number of measurements in a particular pixel-cell is below a threshold, this pixel will be discarded. Thus training process 300 may include a step of evaluating the number of measurements for a regio [symbol] or pixel, and determining whether to use the region for model training based on a threshold.

In some embodiments, the labels 312 may not be direct measurements, but rath [symbol] derived or predicted signal strength values. For example, the signal strengths 312 can be predicted based on deviations of signal strengths between first and second frequency bands, using a different machine learning model. In an embodiment for deriving labels 312, at least o [symbol] source signal strength map is obtained. The at least one source signal strength map describes signal strengths in at least one second frequency band for a coverage area of the wireless communication network. Based on the at least one source signal strength map and the predict [symbol] deviations of signal strengths, at least one target signal strength map describing signal strength in the first frequency band for the coverage area is determined. These determined signal strengths may be used for at least one label 312. Accordingly, in some embodiments, signal strength values for a region are predicted based at least in part on labels that are themselves predicted signal strength values of other regions. That is, a machine learning model may be trained using values obtained from a different machine learning model.

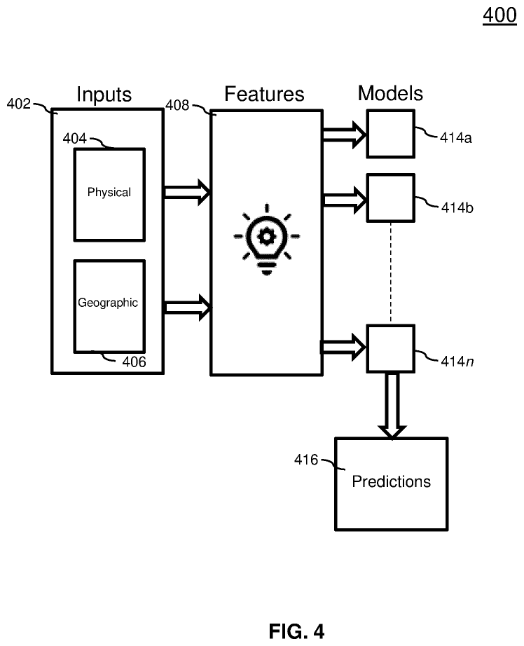

As shown in FIG. 3, the features 308 can be derived based on the inputs 302. F [symbol] example, a set of one or more features is calculated for each of the cell-pixel pairs within the specified area of interest/influence of the cell (e.g., where whole area is divided in tiles, each o [symbol] them represented by a particular pixel). These features can feed the machine learning model 310, first to train the model with pixels where the label (e.g., the signal strength) is known, an [symbol] then to predict a value in regions where it is unknown, for instance, as illustrated in FIG. 4. According to embodiments, the set of derived features 308 for each of the regions can compris [symbol] one or more of delta tilt, delta azimuth, log distance, log distance over breakpoint, log distance over 50% breakpoint, log distance of 150% breakpoint, clutter n log distance [1 . . . N], and clutter n [1 . . . N]. The foregoing are examples, and other features may be derived and used based on the inputs. The delta tilt may be understood as the absolute difference between the antenna tilt (e.g., for an antenna of an access node of the cell) and the impinging vertical angle the region with respect to the antenna. The delta azimuth may be understood as the absolute difference between the antenna azimuth and the impinging horizontal angle of the region with respect to the antenna. The log distance may be understood as the logarithm of the distance (e [symbol] in meters) between the region and the antenna. The log distance over 50% breakpoint may be understood as the logarithm of the distance between the region and 50% of the breakpoint distance, and calculated as:

log distance over 50% breakpoint=log₁₀ (max(1, dₐₙₜₑₙₙₐ₋ₚᵢₓₑₗ[meters]−0.5·d_{BP})

d_{BP}=(5·antenna_{height}·receiver_{height}·f_{c}[MHz]/300)

where dₐₙₜₑₙₙₐ₋ₚᵢₓₑₗ is the distance between the antenna and the center of the region considering only two dimensions. The log distance over breakpoint may be understood as the logarithm of the distance between the region and the breakpoint distance, and calculated as:

log distance over breakpoint=log₁₀ (max(1, dₐₙₜₑₙₙₐ₋ₚᵢₓₑₗ[meters]−d_{BP})),

d_{BP}=(5·antenna_{height}·receiver_{height}·f_{c}[MHz]/300)

where dₐₙₜₑₙₙₐ₋ₚᵢₓₑₗ is the distance between the antenna and the center of the region considering only two dimensions. The log distance of 150% breakpoint may be understood as the logarithm of the distance between the region and 150% of the breakpoint distance, and calculated as:

log distance over 150% breakpoint=log₁₀ (max(1, dₐₙₜₑₙₙₐ₋ₚᵢₓₑₗ[meters]−1.5·d_{BP}))

d_{BP}=(5·antenna_{height}·receiver_{height}·f_{c}[MHz]/300)

where dₐₙₜₑₙₙₐ₋ₚᵢₓₑₗ is the distance between the antenna and the center of the region consideri [symbol] only two dimensions. The clutter n log distance [1 . . . N] may be understood as the logarithm [symbol] the distance that a signal travels through clutter of type n to travel between the antenna and the region. The clutter n [1 . . . N] may be understood as a one hot encoding of the clutter type of t [symbol] region, where the value of clutter n[1 . . . N] is 1 if the clutter type of the region is n or 0 if the clutter type is not n.

According to embodiments, for model training 310, a constrained least squares method can be used. For instance, the training may comprise solving a linear least-squares problem, with one or more bounds on the variables. By way of example, given an m-by-n mat [symbol] A (where m is the number features and n is the number of regions where those features have b [symbol] calculated) and a target vector b with n elements (where b contains the signal strength value o [symbol] for each on the n regions), a machine learning algorithm solves the following optimization problem:

minimize 0.5·∥A·x−b∥² subject to lb≤x≤ub

where lb and ub are the lower and upper bounds of x, respectively.

In some embodiments, the bounds of the coefficients used to multiply the featu [symbol] once the machine learning model is trained are provided. Table 1 shows example bounds for t [symbol] coefficients of each feature:

TABLE 1
Coefficient Bounds

| Feature | Lower Bound | Upper Bound |
|---|---|---|
| Pixel delta tilt | 3/90 | 3 |
| Pixel delta azimuth | 0 | 3 |
| Pixel log distance | 20 | 60 |
| Pixel log distance over 50% | 0 | 60 |
| breakpoint | | |
| Pixel log distance over breakpoint | 0 | 60 |
| Pixel log distance over 150% | 0 | 60 |
| breakpoint | | |
| Clutter n log distance[1 . . . N] | 0 | 60 |
| Pixel clutter N[1 . . . N] | 0 | 60 |

These bounds can be modified, and additional artificial intelligence methods can be applied to adapt the solution to new circumstances. In this example, these coefficients avoid overfitting [symbol] anomalies in the predicted propagation maps.

According to embodiments, the output of the model (e.g., a result of process 30 is a set of coefficients (x), which can then be used for subsequent predictions. The size of the output will depend on the size of the input (e.g., the value of m). For instance, m coefficients may be derived for each cell. According to embodiments, linear regression is used with respe [symbol] to the disclosed models. However, other methods such as deep neural networks or convolutio [symbol] networks can be used when training 310 the models 314a-314n.

In some embodiments, to train a model for a particular cell, not only signal strength values and features of pixels of that cell can be used, but also pixels within the area o [symbol] influence of similar cells. For instance, a similarity indicator can be calculated between differ [symbol] cells, and based on this similarity indicator, pixels of similar cells can be added to the training set. The inclusion of one or more pixels from different cells in the training set, especially whe [symbol] the number of pixels in the cell under consideration is low, can increase accuracy.

Referring now to FIG. 4, a process 400 for predicting signal strength values is provided according to some embodiments. In the example of FIG. 4, one or more models 414 [symbol] 414n are used to predict 416 one or more signal strength values based on features 408. The models 414a-414n may be, for example, generated as described in connection with FIG. 3. Th [symbol] features 408 are obtained for the regions for which signal prediction is needed. For instance, using the example network of FIG. 2, one or more features for region 214 may be obtained, where a model was trained for cell 206 using features from other regions (e.g., 208a, 208b, 21 [symbol] 212b). A signal strength value can then be predicted 416 for region 214 by applying the mode 414 for the cell. According to embodiments, this may comprise multiplying the features 408 b [symbol] a set of coefficients generated by model 414. As another example, a signal strength value coul [symbol] be predicted for region 216 using a model 414 for cell 210. According to embodiments, multi [symbol] values—including values from different cells—may be concurrently predicted using matrix and/or vector multiplications of sets of features and the correct, corresponding model coefficients.

In some embodiments, obtaining features 408 may comprise deriving the featur [symbol] from inputs 402, such as physical inputs 404 and geographic inputs 406. These features may [symbol] derived, for instance, in the same manners as described with respect to FIG. 3 and the training process 300.

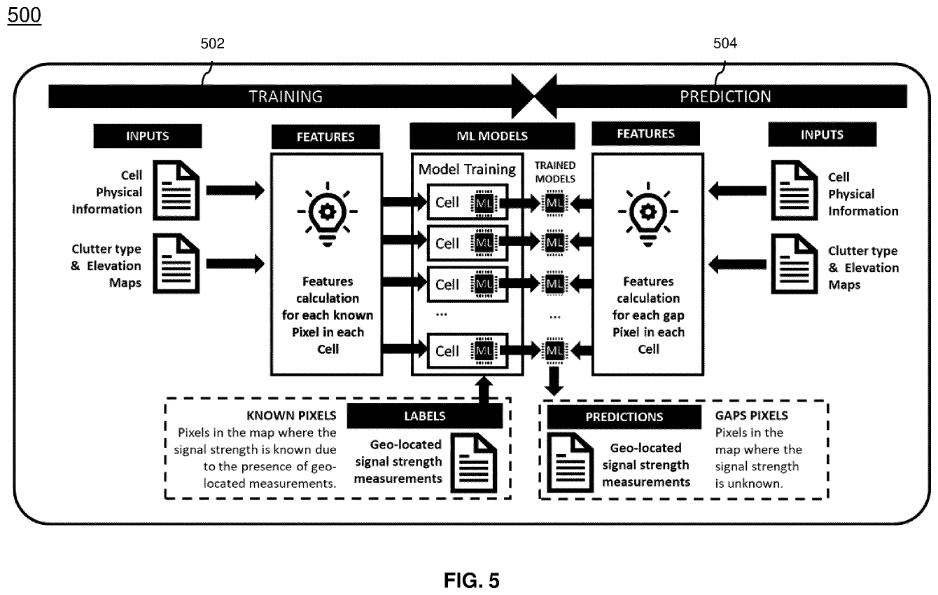

Referring now to FIG. 5, a flow chart illustrating machine learning model traini [symbol] and signal strength prediction processes is provided. FIG. 5 illustrates a way in which model training 502 and model application (e.g., prediction) 504 can interact according to embodimen [symbol] In certain aspects, process 500 can leverage machine learning to predict signal strength in a gi [symbol] region based on measurements of the same cell or similar cells in the same (or in a similar) network. This may have a number of advantages in terms of flexibility and accuracy. For instance, the inputs used during training phase 502 can be obtained from different data sources including crowdsourced data, which makes the process 500 flexible, robust, and, from the operator point of view, easy to apply. As another example, the definition of the features (e.g., described in connection with FIGS. 3 and 4) can allow the synthesis of all of the information available in the geo-located signal strength measurements, cell information databases, and clut [symbol] and elevation maps with high accuracy for the signal strength predictions. Additionally, the us [symbol] of measurements of its own or similar cells can give the model the ability to learn singularities anomalies from a particular cell, type of terrain, orography, etc. Moreover, the signal strength measurements can be obtained from different sources (e.g. crowdsourced data, UE measureme [symbol] messages, walk and drive tests, etc.), which can make the algorithm flexible and easy to apply. As described above, one of the potential sources for signal strength measurements is the crowdsourced data, which is easily accessible for most of the markets in the word without the operator collaboration. Moreover, clutter and elevation maps can be obtained from different sources. Therefore, in some embodiments, one can obtain complete propagation maps by providing cell parameters and antenna transmit power, or at a minimum in some cases, also providing clutter and elevation maps. In other respects, the number of pixels with signal stren [symbol] per cell does not have to be particularly high to practice the methods. For instance, as few as [symbol] pixels may be enough to train a reliable model in some cases, and furthermore, the model can [symbol] pixels from other cells that are deemed sufficiently similar in order to complete the training dataset. This makes the algorithm very flexible and makes it possible to manage large geographical areas without a burdensome computational effort. According to some embodiments, a different model is trained for each cell. This gives each model the ability to le [symbol] singularities or anomalies of a particular cell, type of terrain, orography, etc. As a result, highl [symbol] accurate and adaptable models can be obtained.

According to embodiments, the use of machine learning increases the accuracy the method as compared with classical propagation models. For instance, aspects of the disclosure can avoid the situation where inputs that are very important for a generic scenario a [symbol] irrelevant in a particular cell, but nonetheless used (or on the other hand, an irrelevant input fo [symbol] generic scenario can be very important in another cell but overlooked). Moreover, the same methodology disclosed herein can be applied with different artificial intelligence methods. Th [symbol] disclosed models can be easily evolved to adapt to changes in the nature of the input (number [symbol] samples, complexity of clutter type definition, new features, etc.).

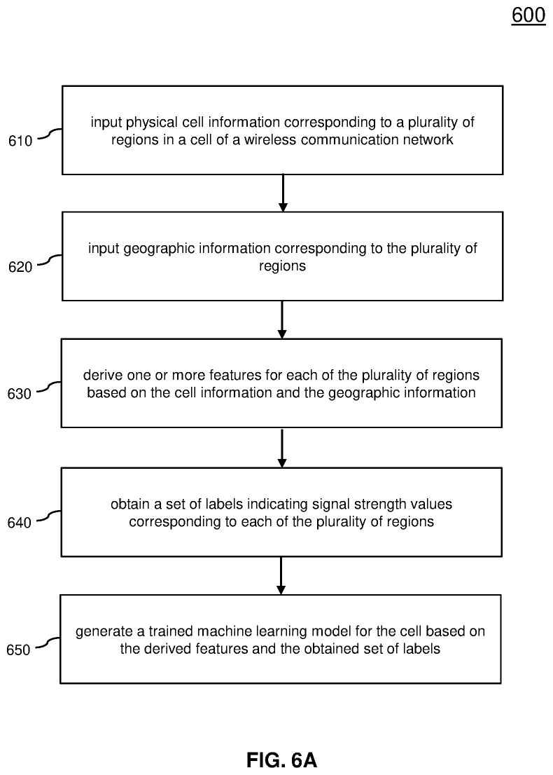

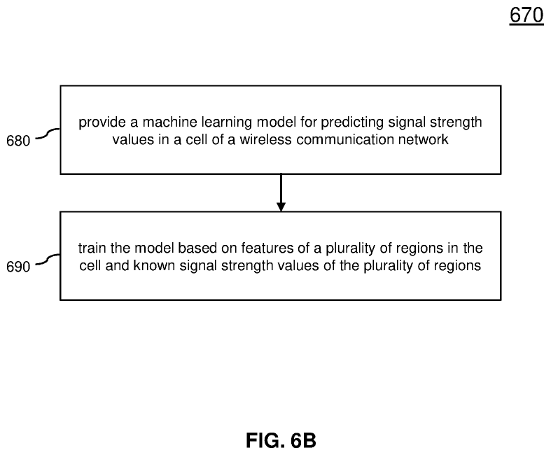

Referring now to FIG. 6A, a process 600 is provided according to some embodiments. In certain aspects, process 600 is a process for generating a machine learning model. For instance, process 600 can be used to generate one or more machine learning mode [symbol] 314a-314n as described in connection with FIG. 3. In some embodiments, process 600 may b [symbol] applied in connection with wireless communication networks 100 and 200, for instance, to generate a model for cells 206 and/or 210. Process 600 may output a set of coefficients that ca [symbol] be used to predict signal strength in the cell used to train the model.

In some embodiments, the process 600 may begin with step 610, in which physical cell information corresponding to a plurality of regions in a cell of a wireless communication network is input. In step 620, geographic information corresponding to the plurality of regions is input. The input of information in steps 610 and 620 may take different forms, including as examples direct manual input, loading the information from a memory or other database, or extracting the information from a source, such as a map. For instance, the geographic information of step 620 may be input in the form of a clutter type or elevation map In step 630, one or more features are derived for each of the plurality of regions based on the c [symbol] and geographic inputs. In step 640, a set of labels is obtained, where the labels' signal strengt [symbol] values correspond to each of the plurality of regions. The derived features and labels can be u [symbol] to train a machine learning model. In step 650, a trained machine learning model is generated for the cell based on the derived features and the obtained set of labels. According to some embodiments, steps 610 and 620 may be optional where the features needed for the model training are previously derived, such that step 630 comprises obtaining or otherwise directly inputting the features. That is, process 600 may begin with previously derived features and labels.

Referring now to FIG. 6B, a process 670 is provided according to some embodiments. In certain aspects, process 670 is a process for training a machine learning mod [symbol] For instance, process 670 can be used to train one or more machine learning models 314a-314 [symbol] as described in connection with FIG. 3. In some embodiments, process 670 may be applied in connection with wireless communication networks 100 and 200, for instance, to generate a model for cells 206 and/or 210. The process may begin with step 680, in which a machine learning model for predicting signal strength values in a cell of a wireless communication network is provided. According to embodiments, the model is based on a constrained least squares optimization approach. In step 690, the model is trained based on features of a plurali [symbol] of regions in the cell and known signal strength values of the plurality of regions. This proces [symbol] 670 may corresponded, for instance, to one or more steps of processes 300 and 500.

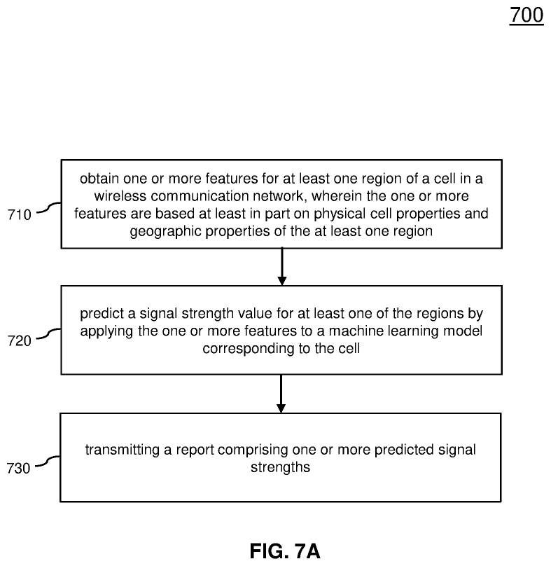

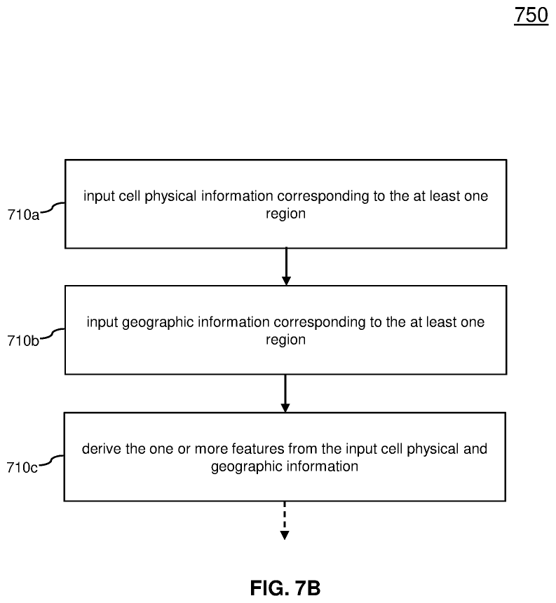

Referring now to FIG. 7A, a process 700 is provided according to some embodiments. In certain aspects, process 700 is a process for predicting signal strength values using a machine learning model, such as models 414a-414n. For instance, process 700 can be used to derive one or more predicted values 416 as described in connection with FIG. 4. In so [symbol] embodiments, process 700 may be applied in connection with wireless communication networ [symbol] 100 and 200, for instance, to generate predicted values for regions 214 and 216.

According to embodiments, process 700 may begin with step 710, which comprises obtaining one or more features for at least one region of a cell in a wireless communication network. The one or more features are based at least in part on physical cell properties and geographic properties of the at least one region. In step 720, a signal strength value is predicted for at least one of the regions by applying the one or more features to a machine learning model corresponding to the cell. In step 730, an action is taken using the predicted values. For instance, a report can be transmitted that comprises one or more of the predicted signal strengths. This may be in numerical form, or in the form of a coverage map ( [symbol] partial map). Other actions that may be taken in addition to report transmission in step 730, or instead of report transmission in step 730, include: generation of a propagation map, configuri [symbol] parameters relevant for operation of the wireless communication network, such as RF (radio frequency) parameters applied by the access nodes 101-1, 101-2, 101-3, 101-4 or UE 10, and planning modification or expansion of a wireless communication network. As an example, th [symbol] predicted values can be used for antenna tilt optimization.

Referring now to FIG. 7B, a process 750 is provided for deriving one or more features according to embodiments. Process 750 may be, for examples, a method for obtainin [symbol] features 710 as described with respect to FIG. 7A. Process 750 may begin with step 710a, in which physical cell information corresponding to the at least one region is input. In step 710b, geographic information corresponding to the at least one region is input. In step 710c, the one more features are derived from the input physical cell and geographic information. That is, in process 700, the features may be obtained by deriving them from inputs.

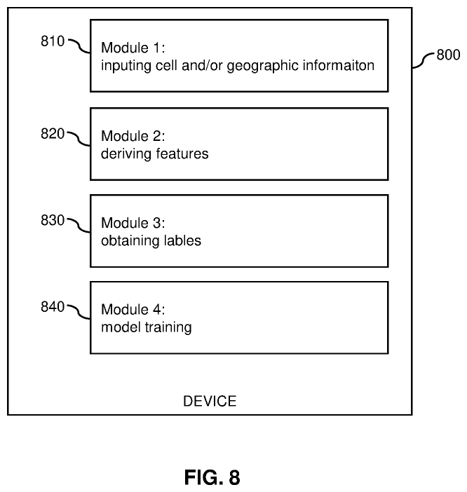

Referring now to FIG. 8 a block diagram illustrates functionalities of a device 800, which operates according to the methods of one or more of FIGS. 3, 6A, and 6B. The device may for example correspond to the above-mentioned OSS 180 or the above-mentioned network planning tool 190. According to other embodiments, the device may correspond to a UE or access node. As illustrated, the device 800 may be provided with a module 810 configured to input cell and/or geographic information, such as explained in connection with steps 302, 610, and 620. Further, the device 800 may be provided with a module 820 configur [symbol] to derive features, such as explained in connection with steps 308 and 630. Further, the devic [symbol] 800 may be provided with a module 830 configured to obtain labels, such as explained in connection with steps 312 and 640. Further, the device 800 may be provided with a module 8 [symbol] configured to train a machine learning model, such as explained in connection with steps 310, 650, 680, and 690.

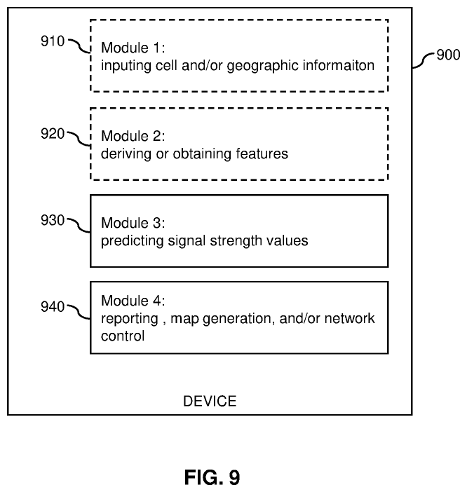

Referring now to FIG. 9 a block diagram illustrates functionalities of a device 900, which operates according to the methods of one or more of FIGS. 4, 7A, and 7B. The device may for example correspond to the above-mentioned OSS 180 or the above-mentioned network planning tool 190. According to other embodiments, the device may correspond to a UE or access node. As illustrated, the device 900 may be optionally provided with a module 9 configured to input cell and/or geographic informaiton, such as explained in connection with steps 402, 710a, and 710b. Further, the device 900 may be optionally provided with a module 920 configured to derive or obtain features, such as explained in connection with steps 408 an [symbol] 710. Further, the device 900 may be provided with a module 930 configured to predict signal strength values, such as explained in connection with steps 416 and 720. Further, the device 9 [symbol] may be provided with a module 940 configured to report predicted values, generate a coverage map, and/or perform one or more network control function, such as explained in connection w [symbol] step 730.

According to embodiments, the modules of devices 800 and 900 may be combined into a single device, such as an OSS 180 or network planning tool 190.

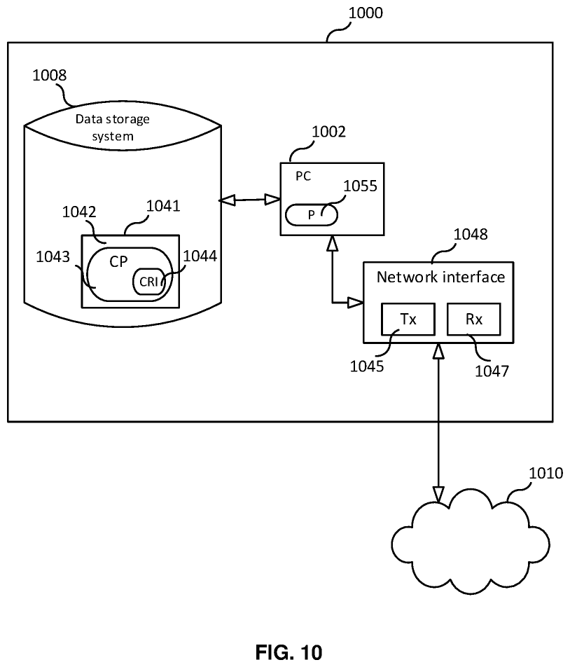

FIG. 10 is a block diagram of an apparatus 1000 (e.g., an OSS 180, network planning tool 190, UE 10, or access node 101-1, 101-2, 101-3, 101-4), according to some embodiments. As shown in FIG. 10, the apparatus may comprise: processing circuitry (PC) 1002, which may include one or more processors (P) 1055 (e.g., a general purpose microprocessor and/or one or more other processors, such as an application specific integrated circuit (ASIC), field-programmable gate arrays (FPGAs), and the like); a network interface 10 [symbol] comprising a transmitter (Tx) 1045 and a receiver (Rx) 1047 for enabling the apparatus to transmit data to and receive data from other nodes connected to a network 1010 (e.g., an Interr [symbol] Protocol (IP) network) to which network interface 1048 is connected; and a local storage unit (a.k.a., “data storage system”) 1008, which may include one or more non-volatile storage devi [symbol] and/or one or more volatile storage devices. In embodiments where PC 1002 includes a programmable processor, a computer program product (CPP) 1041 may be provided. CPP 104 includes a computer readable medium (CRM) 1042 storing a computer program (CP) 1043 comprising computer readable instructions (CRI) 1044. CRM 1042 may be a non-transitory computer readable medium, such as, magnetic media (e.g., a hard disk), optical media, memor [symbol] devices (e.g., random access memory, flash memory), and the like. In some embodiments, the CRI 1044 of computer program 81043 is configured such that when executed by PC 1002, the CRI causes the apparatus to perform steps described herein (e.g., steps described herein with reference to the flow charts). In other embodiments, the apparatus may be configured to perfo [symbol] steps described herein without the need for code. That is, for example, PC 1002 may consist merely of one or more ASICs. Hence, the features of the embodiments described herein may [symbol] implemented in hardware and/or software.

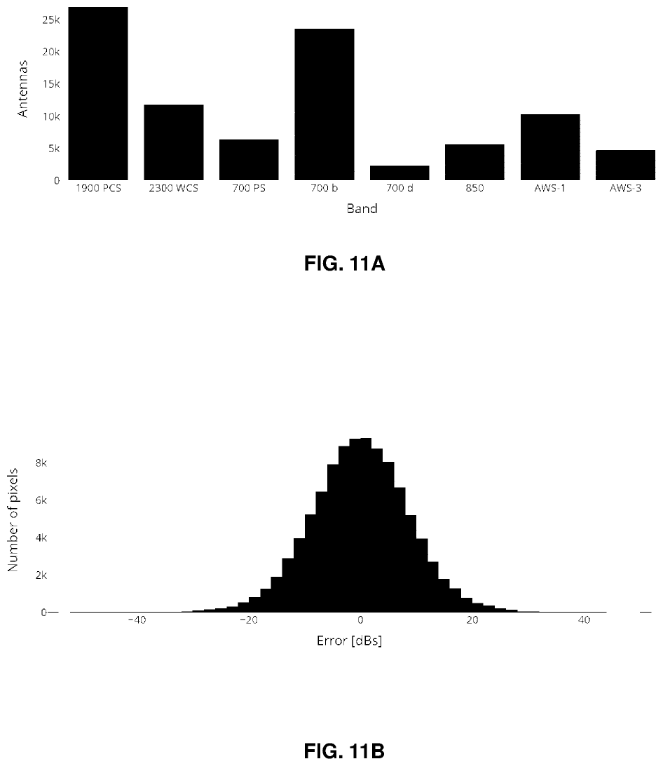

Referring now to FIGS. 11A and 11B, test results of an LTE (Long Term Evolution) network using aspects of the present disclosure are provided. As shown in FIG. 11 predictions of signal strength, RSRP in this case using LTE, were derived over more than 100 [symbol] cells of different bands. The entire area was divided into pixels of 25 meters×25 meters for t [symbol] evaluation. In this example, for each cell, only pixels where the RSRP was known due to the presence of crowdsourced data samples were selected, considering only pixels with more than three crowdsource samples. According to embodiments, however, other samples and sizes co [symbol] be used. Additionally, in each cell, an area including 10% of the pixels with valid measureme [symbol] was excluded from the training set and used in order to test the accuracy of the model. FIG. 1 [symbol] shows the error distribution for all the pixels in the testing set of all the cells. The mean error was −0.01 dB, with a standard deviation of 7.52. Thus, high accuracy prediction was demonstrated. Given the strength of the results, embodiments could be used to predict signal strength in cells for which no existing signal strength measurement are known. For instance, i [symbol] cell having similar features as a cell used to train a model.

While various embodiments of the present disclosure are described herein, it should be understood that they have been presented by way of example only, and not limitatio [symbol] Thus, the breadth and scope of the present disclosure should not be limited by any of the abov [symbol] described exemplary embodiments. Moreover, any combination of the above-described eleme [symbol] in all possible variations thereof is encompassed by the disclosure unless otherwise indicated herein or otherwise clearly contradicted by context.

Additionally, while the processes described above and illustrated in the drawin [symbol] are shown as a sequence of steps, this was done solely for the sake of illustration. Accordingly is contemplated that some steps may be added, some steps may be omitted, the order of the ste [symbol] may be re-arranged, and some steps may be performed in parallel.

Generally, all terms used herein are to be interpreted according to their ordinar [symbol] meaning in the relevant technical field, unless a different meaning is clearly given and/or is implied from the context in which it is used. All references to a/an/the element, apparatus, component, means, step, etc. are to be interpreted openly as referring to at least one instance o [symbol] the element, apparatus, component, means, step, etc., unless explicitly stated otherwise. The steps of any methods disclosed herein do not have to be performed in the exact order disclosed unless a step is explicitly described as following or preceding another step and/or where it is implicit that a step must follow or precede another step.

Any feature of any of the embodiments disclosed herein may be applied to any other embodiment, wherever appropriate. Likewise, any advantage of any of the embodiment [symbol] may apply to any other embodiments, and vice versa. Other objectives, features and advantag [symbol] of the enclosed embodiments will be apparent from the following description.

In general, the usage of “first”, “second”, “third”, “fourth”, and/or “fifth” herei [symbol] may be understood to be an arbitrary way to denote different elements or entities, and may be understood to not confer a cumulative or chronological character to the nouns they modify, unless otherwise noted, based on context.

Several embodiments are comprised herein. It should be noted that the exampl [symbol] herein are not mutually exclusive. Components from one embodiment may be tacitly assumed be present in another embodiment and it will be obvious to a person skilled in the art how thos [symbol] components may be used in the other exemplary embodiments

The embodiments herein are not limited to the above described embodiments. Various alternatives, modifications and equivalents may be used. Therefore, the above embodiments should not be taken as limiting the scope of the embodiments. A feature from o [symbol] embodiment may be combined with one or more features of any other embodiment.

The term “at least one of A and B” should be understood to mean “only A, only B, or both A and B.”, where A and B are any parameter, number, indication used herein etc.

It should be emphasized that the term “comprises/comprising” when used in thi [symbol] specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

It should also be emphasized that the steps of the methods may, without departi [symbol] from the embodiments herein, be performed in another order than the order in which they app [symbol] herein.

1. A method of generating a machine learning model, the method comprising:
inputting physical cell information corresponding to a first plurality of regions in a first cell of a wireless communication network;
inputting geographic information corresponding to the first plurality of regions;
deriving one or more features for each of the first plurality of regions based on the cell information and the geographic information;
obtaining a set of labels indicating signal strength values corresponding to each of the first plurality of regions; and
generating a trained machine learning model for the first cell based on the derived features and the obtained set of labels.

2. The method of claim 1, further comprising:
applying the model to determine a predicted signal strength value corresponding to one or more regions of a second plurality of regions in the first cell,
wherein the second plurality of regions are different than the first plurality of regions.

3. The method of claim 1, wherein the first cell is served by a node having an antenna, and the physical cell information comprises one or more of:
(i) an identifier of the first cell;
(ii) latitude of the antenna;
(iii) longitude of the antenna;
(iv) azimuth of the antenna;
(v) antenna tilt;
(vi) antenna altitude;
(vii) antenna transmit power; and
(viii) antenna beam width.

4. The method of claim 1, wherein the geographic information comprises one or more of clutter information and elevation information.

5. The method of claim 1, wherein the first cell is served by a node having an antenna, and the derived features comprise one or more of:
(i) delta tilt;
(ii) delta azimuth;
(iii) log distance;
(iv) log distance over breakpoint;
(v) log distance over 50% breakpoint;
(vi) log distance of 150% breakpoint;
(vii) clutter n log distance [1 . . . N]; and
(viii) clutter n [1 . . . N].

6. The method of claim 1, wherein the obtained set of labels are geo-located signal strength measurements corresponding to signals from an antenna of the first cell.

7. The method of claim 6, wherein the set of labels are obtained from one or more of the following sources:
(i) measurement messages sent from User Equipment, UEs, located within the first plurality of regions;
(ii) walk and drive tests performed in the first plurality of regions; and
(iii) crowd-sourced data obtained from applications installed on one or more UEs located within the first plurality of regions.

8. The method of claim 1, wherein the step of obtaining the labels comprises:
predicting one more signal strength values based at least in part of deviations in signal strength between first and second frequency bands, and wherein one or more of the labels in the obtained set of labels is the one or more predicted signal strength values.

9. The method of claim 1, wherein the step of generating the machine learning model comprises performing a constrained least squares optimization using the derived features and set of labels.

10. The method of claim 1, wherein generating the machine learning model comprises solving the following optimization function:
minimize 0.5·∥A·x−b∥² subject to lb≤x≤ub.
where A is an m-by-n matrix, in is the number of derived features for each region, n is the number of regions in the first plurality of regions, b is a vector with n elements that contains the obtained labels corresponding to the signal strength for each of the n regions, and lb and ub are the lower and upper bounds of x, respectively.

11. The method of claim 10, wherein at least one of the lower bounds lb for a given feature has a non-zero value.

12. The method of claim 1, further comprising:
obtaining one or more features for at least one region located in a second cell of the wireless communication network; and
obtaining one or more labels indicating signal strength values corresponding to the at least one region of the second cell,
wherein the generating a machine learning model for the first cell is based at least in part on the features and labels for the at least one region of the second cell.

13. The method of claim 12, wherein obtaining the one or more features for the at least one region located in the second cell comprises:
deriving the features based on the physical cell information and the geographic information of the at least one region located in the second cell.

14. The method of claim 12, wherein the at least one region of the second cell has similar physical cell properties and similar geographic properties of a region located in the first cell.

15. A method of managing a wireless communication network, the method comprising:
obtaining one or more features for at least one region of a cell in the wireless communication network, wherein the one or more features are based at least in part on physical cell properties and geographic properties of the at least one region; and
predicting a signal strength value for the at least one region by applying the one or more features to a machine learning model corresponding to the cell.

16. The method of claim 15, wherein obtaining the one or more features comprises:
inputting physical cell information corresponding to the at least one region;
inputting geographic information corresponding to the at least one region; and
deriving the one or more features from the input physical cell and geographic information.

17. The method of claim 15, further comprising:
transmitting a report comprising one or more predicted signal strength values.

18. (canceled)

19. The method of claim 15, wherein applying the one or more features to the machine learning model comprises multiplying the features by a set of coefficients.

20. (canceled)

21. (canceled)

22. The method of claim 15, further comprising:
generating a coverage map of the cell, wherein the coverage map comprises both measured signal strength values and the predicted signal strength values.

23. The method of claim 15, further comprising:
configuring one or more parameters relevant for operation of the wireless communication network based at least in part on a predicted signal strength value.

24-33. (canceled)
